(19) United States
(12) Patent Application Publication
(10) Pub. No.: US 2026/0039136 A1
(43) Pub. Date: Feb. 5, 2026

(54) BATTERY MANAGEMENT SYSTEM

(71) Applicant: EnerVenue Holdings, Ltd., Fremont, CA (US)

(72) Inventors: Jacob Lamkin, Fremont, CA (US); Hrishikesh Zurange, Fremont, CA (US); Ronan Tennant, Fremont, CA (US)

(21) Appl. No.: 19/282,373

(22) Filed: Jul. 28, 2025

Related U.S. Application Data
(60) Provisional application No. 63/678,451, filed on Aug. 1, 2024.

(51) Int. Cl. H02J 7/00; H01M 10/42; H01M 10/44; H01M 10/48

(52) U.S. Cl. CPC H02J 7/00712; H01M 10/425; H01M 10/441; H01M 10/486; H02J 7/00032; H02J 7/0013; H02J 7/0048; H02J 7/005; H01M 2010/4271

(57) ABSTRACT

According to some embodiments, a battery management system for a metal-hydrogen battery system is presented. In particular, a method of managing a battery system includes applying a charging current through a battery string of the battery system, the battery string including a plurality of coupled batteries; monitoring temperature of the plurality of batteries; determining a maximum charging voltage from a Vtable that relate the charging current, the temperature, and the maximum charging voltage for each battery in the battery string; and stopping the charging current when a voltage across one or more of the batteries of the battery string reaches the maximum charging voltage.

### RELATED APPLICATIONS

This disclosure claims priority to U.S. Provisional Application 63/678,451, filed on Aug. 1, 2024, which is herein incorporated by reference in its entirety.

### TECHNICAL FIELD

This disclosure is generally related to metal-hydrogen batteries, and more particularly to a battery management system for metal-hydrogen batteries.

### DISCUSSION OF RELATED ART

For renewable energy resources such as wind and solar to be competitive with traditional fossil fuels, large-scale energy storage systems are needed to mitigate their intrinsic intermittency. To build large-scale energy storage, the cost and long-term lifetime are the utmost considerations. Currently, pumped-hydroelectric storage dominates the grid energy storage market because it is an inexpensive way to store large quantities of energy over a long period of time (about 50 years), but it is constrained by the lack of suitable sites and the environmental footprint. Other technologies such as compressed air and flywheel energy storage show some different advantages, but their relatively low efficiency and high cost should be significantly improved for grid-scale storage. Rechargeable batteries offer great opportunities to target low-cost, high-capacity and highly reliable systems for large-scale energy storage. Improving the reliability and deploy ability of rechargeable batteries and reducing cost of those batteries has become an important issue to realize large-scale energy storage.

Managing charge and discharge cycles in a battery system that results in high efficiency energy storage systems remains a significant challenge for operation of battery storage systems. Consequently, there is a need for better battery management systems for controlling the operation of battery systems.

### SUMMARY

According to some embodiments, a battery management system for a metal-hydrogen battery system is presented. In particular, a method of managing a battery system includes applying a charging current through a battery string of the battery system, the battery string including a plurality of coupled batteries; monitoring temperature of the plurality of batteries; determining a maximum charging voltage from a Vtable that relate the charging current, the temperature, and the maximum charging voltage for each battery in the battery string; and stopping the charging current when a voltage across one or more of the batteries of the battery string reaches the maximum charging voltage. In some embodiments, the method further includes monitoring a state of health (SOH) of the plurality of coupled batteries, wherein the Vtables relate the charging current, the temperature, the maximum charging voltage, and the SOH. In some embodiments, the maximum charging voltage is set in the Vtable such that, when the voltage across one of the batteries in the battery string is at the maximum charging voltage, that battery is at a state-of-charge (SOC) greater than a nominal SOC of 100%. In some embodiments, the maximum charging voltage is set high enough to promote balancing of the plurality of batteries in the battery string at the top of charge.

In some embodiments, the method further includes monitoring parameters regarding each of the plurality of batteries in the battery string; and determining conditions of each of the plurality of batteries based on a mathematical model. In some embodiments, monitoring parameters includes determining a voltage across each battery in the plurality of batteries. In some embodiments, determining conditions includes determining a state-of-charge. In some embodiments, the method further includes adjusting the charging current in response to the determined conditions of each of the plurality of batteries.

In some embodiments, the method further includes transitioning to an idle state. In some embodiments, transition to the idle state occurs after stopping the charging current or in response to conditions of one or more of the plurality of batteries in the battery string. In some embodiments, the method further includes applying a trickle charge current during the idle state. In some embodiments, applying the trickle charge current enhances balancing of the battery string.

In some embodiments, the method further includes transitioning to a discharge state. In some embodiments, the method further includes, in the discharge state, providing discharge current from the battery string and stopping the discharge current when a minimum discharge voltage is reached. In some embodiments, the method further includes controlling the discharge capacity based on coulomb counting. In some embodiments, the method further includes determining the SOC of the battery by interpolation between the maximum charge voltage defining a top-of-charge and a minimum discharge voltage defining a bottom-of-charge state and using a Kalman filter with an amp-hour count. In some embodiments, the minimum discharge voltage is set high enough such that none of the plurality of batteries in the battery string are over discharged at the SOC defined by the minimum discharge voltage. In some embodiments, the minimum discharge voltage is based on a battery of the plurality of batteries that will reach the bottom-of-charge state during discharge before other batteries of the plurality of batteries.

In some embodiments, the method further includes tracking discharge capacity of the battery string. In some embodiments, estimating a state-of-charge during charging using a recharging ratio, which is determined by coulomb counting the number of amp-hours in the battery string. In some embodiments, the number of amp-hours is discounted according to coulombic efficiency of each of the plurality of batteries. In some embodiments, the number of amp-hours can be temperature compensated. In some embodiments, the recharging ratio is calibrated with a lower coulombic efficiency than a lowest performing battery of the plurality of batteries.

In some embodiments, a battery management system (BMS) includes a battery interface configured to communicate with battery monitors, the battery monitors configured to monitor parameters of a plurality of batteries, the plurality of batteries being coupled to form a battery string; a terminal interface, the configured to communicate with terminal electronics, the terminal electronics configured to control current and voltage of the battery string in accordance with control signals received from the terminal interface; a memory, the memory configured to hold instructions and data; and a processor coupled to the memory, the terminal interface, and the battery interface, wherein the processor executes instructions stored in the memory to provide control signals to the terminal interface to direct the terminal electronics to apply a charging current through the battery string, the battery string including a plurality of coupled batteries; monitor temperature of the plurality of batteries through the battery interface; determine a maximum charging voltage from a Vtable that relate the charging current, the temperature, and the maximum charging voltage for each of the plurality of batteries; and provide control signals to the terminal interface to stop the charging current when a voltage across one or more of the plurality of batteries in the battery string reaches the maximum charging voltage.

In some embodiments, the BMS further includes instructions to monitor a state of health (SOH) of the plurality of coupled batteries, wherein the Vtables relate the charging current, the temperature, the maximum charging voltage, and the SOH. In some embodiments, the maximum charging voltage is set in the Vtable such that, when the voltage across one of the batteries in the battery string is at the maximum charging voltage corresponding to a top of charge (TOC), that battery is at a state-of-charge (SOC) greater than a nominal SOC of 100%. In some embodiments, the maximum charging voltage is set high enough to promote balancing of the plurality of batteries in the battery string at the TOC.

In some embodiments, the BMS further includes instructions to monitor parameters through the battery interface regarding each of the plurality of batteries in the battery string; and determine conditions of each of the plurality of batteries based on a mathematical model. In some embodiments, monitoring parameters includes determining a voltage across each battery in the plurality of batteries. In some embodiments, determining conditions includes determining a state-of-charge of each of the plurality of batteries. In some embodiments, the BMS further includes instructions to adjust the charging current in response to the determined conditions of each of the plurality of batteries.

In some embodiments, the BMS includes instructions to transition to an idle state. In some embodiments, transition to the idle state occurs after stopping the charging current or in response to conditions of one or more of the plurality of batteries in the battery string. In some embodiments, the BMS further includes instructions to provide control signals through the terminal interface to apply a trickle charge current during the idle state. In some embodiments, applying the trickle charge current enhances balancing of the battery string.

In some embodiments, the BMS further includes instructions to transition to a discharge state. In some embodiments, the BMS further includes instructions for, in the discharge state, to provide control signals to the terminal interface for providing discharge current from the battery string. In some embodiments, the BMS further includes instructions to control the discharge capacity based on coulomb counting. In some embodiments, the BMS further includes instructions to determine the SOC of the battery by interpolation between the maximum charge voltage defining a top-of-charge and a minimum discharge voltage defining a bottom-of-charge state and using a Kalman filter with an amp-hour count. In some embodiments, the minimum discharge voltage is set high enough such that none of the plurality of batteries in the battery string are over discharged at the SOC defined by the minimum discharge voltage. In some embodiments, the minimum discharge voltage is based on a battery of the plurality of batteries that will reach the bottom-of-charge state during discharge before other batteries of the plurality of batteries. In some embodiments, the BMS further includes instructions to track discharge capacity of the battery string.

In some embodiments, the BMS further includes instructions to estimate a state-of-charge during charging using a recharging ratio, which is determined by coulomb counting the number of amp-hours in the battery string. In some embodiments, the number of amp-hours is discounted according to coulombic efficiency of each of the plurality of batteries. In some embodiments, the number of amp-hours can be temperature compensated. In some embodiments, the recharging ratio is calibrated with a lower coulombic efficiency than a lowest performing battery of the plurality of batteries.

These and other embodiments are discussed below with respect to the following figures.

### BRIEF DESCRIPTION OF THE FIGURES

FIG. 1A illustrates a battery system with a battery management system according to some embodiments of the present disclosure.

FIG. 1B illustrates an example of a battery that can be used in the battery system illustrated in FIG. 1A.

FIG. 1C further illustrates an example of a battery system as illustrated in FIG. 1A.

FIG. 1D illustrates a monitor as is illustrated in the example of FIG. 1C.

FIG. 1E illustrates a block diagram of a battery management system (BMS) as illustrated in FIGS. 1A and 1C.

FIG. 2 illustrates a state diagram for operation of the BMS as illustrated in FIG. 1E.

FIGS. 3A and 3B illustrate determination of a three-dimensional (3D) Vtable according to some embodiments of the present disclosure.

FIG. 4 illustrates operational ranges for a battery system as illustrated in FIG. 1A with the BMS as illustrated in FIG. 1E according to some embodiments of the present disclosure.

FIG. 5 illustrates determining a mathematical model for characterizing individual batteries in a battery system as illustrated in FIG. 1A according to some embodiments of the present disclosure.

FIG. 6 illustrates charge control using embodiments of the present disclosure on several individual batteries.

FIG. 7 illustrates testing of a battery system using embodiments of the present disclosure.

FIGS. 8A, 8B, and 8C illustrate method of performing a charging state, a discharge state, and an idle state as illustrated in FIG. 2 and discussed above.

These figures along with other embodiments are further discussed below.

### DETAILED DESCRIPTION

In the following description, specific details are set forth describing some embodiments of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure.

This description illustrates inventive aspects and embodiments should not be taken as limiting—the claims define the protected invention. Various changes may be made without departing from the spirit and scope of this description and the claims. In some instances, well-known structures and techniques have not been shown or described in detail in order not to obscure the invention.

Embodiments of the present disclosure provide for an activation procedure for batteries that can be performed as the battery is being deployed and at the site of deployment. The activation process according to some embodiments of the present invention can, for example, be performed on metal hydrogen batteries.

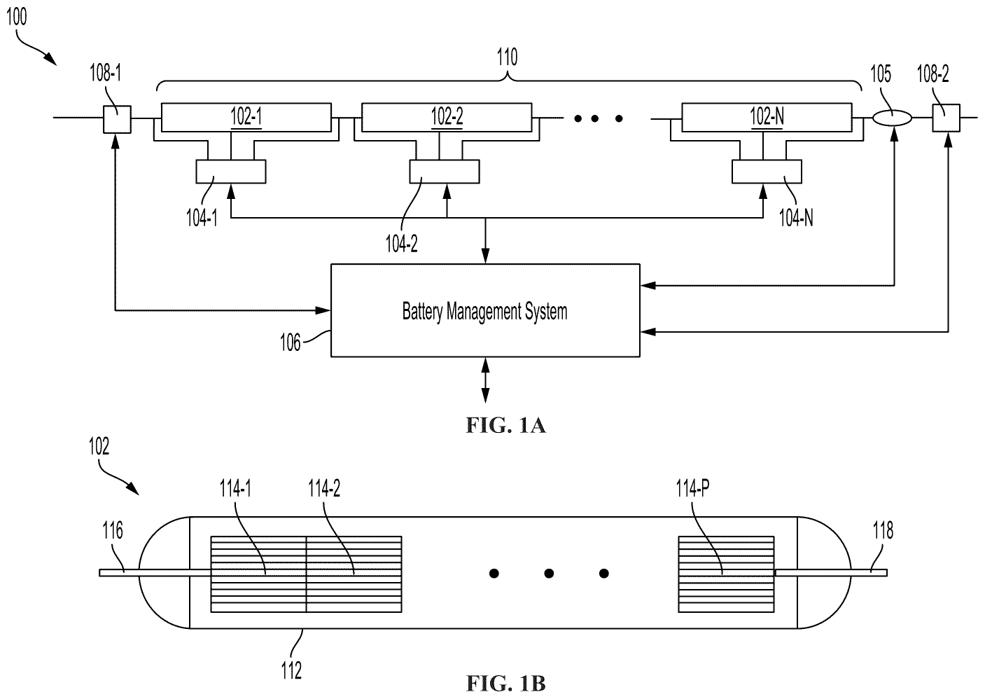

FIG. 1A illustrates a battery system 100 according to some embodiments of the present disclosure. As shown in FIG. 1A, battery system 100 includes N individual batteries 102 (batteries 102-1 through 102-N) that are electrically coupled to form a string 110. In the particular example illustrated in FIG. 1A, batteries 102-1 through 102-N are coupled in series to form string 110, however other arrangements are possible. For example, if N=50 and each of batteries 102 has a 30V voltage at 100% nominal state-of-charge (SOC), then the series coupled battery string 110 illustrated in FIG. 1A can have a 1500V nominal battery voltage.

Although FIG. 1A illustrates a battery arrangement 100 where N batteries 102 are coupled in series, batteries 102 can be electrically coupled in parallel as well. Further, battery arrangement 100 can be electrically coupled in a combination of parallel and serial connections according to some embodiments of the present disclosure.

In some embodiments of the present disclosure, batteries 102 can be metal hydrogen batteries. Metal hydrogen batteries have been described in more detail in U.S. patent application Ser. No. 17/830,193, entitled “Electrode Stack Assembly for a Metal Hydrogen Battery,” filed on Jun. 1, 2022, which is herein incorporated by reference. Another embodiment of electrode stack 101 is described in U.S. patent application Ser. No. 17/687,527, entitled “Electrode Stack Assembly for a Metal Hydrogen Battery,” filed on Mar. 4, 2022, which is also incorporated by reference in its entirety. Other examples of a metal-hydrogen battery have been disclosed in U.S. Prov. Application 63/658,165 entitled “Nickel-Hydrogen Battery Configurations for Grid-Scale Energy Storage,” filed on Jun. 10, 2024, which is also herein incorporated by reference in its entirety.

FIG. 1B illustrates an example of a Ni—H₂ battery 102 as is illustrated in FIG. 1A. As shown in FIG. 1B, battery 102 is formed with a plurality of coupled stacks 114-1 through 114-P housed in a pressure vessel 112. Pressure vessel 112 can be a composite overlay (COPV) or may be formed of other materials sufficient to contain the pressurized contents of the pressure vessel battery 102. Stacks 114-1 through 114-P can be formed with layers of anode and cathode electrodes in an electrolyte to form cells of battery 102. Arrangements of electrode stacking in stacks 114-1 through 114-P are described in full in the applications incorporated above. As is further illustrated in FIG. 1B, feedthroughs 116 and 118 provide electrical connection with the coupled stacks 114-1 through 114-P. In some embodiments, as illustrated in FIG. 1B, stacks 114-1 through 114-P are coupled in series, although other arrangements may also be used. As is further illustrated, one of feedthroughs 116 and 118 are coupled to anode electrodes in stack 114-1 and the other of feedthroughs 116 and 118 are coupled to cathode electrodes in stack 114-P to form terminals of battery 102. In a particular example, stacks 114-1 through 114-P are coupled in series. Further, in some examples each of stacks 114-1 through 114-P each have a nominal maximum voltage of 1.66V so that if P=18 then the voltage across terminals 116 and 118 has a nominal voltage of 30V.

As further shown in FIG. 1A, each of batteries 102-1 through 102-N is coupled to a corresponding monitoring system 104-1 through 104-N. Monitoring systems 104-1 through 104-N can store parameters that are associated with the corresponding one of batteries 102-1 through 102-N and includes sensors for monitoring the operation of each of batteries 102-1 through 102-N. Further, a battery management system (BMS) 106 is coupled monitoring systems 104-1 through 104-N. BMS 106 receives data from sensors monitoring parameters from each of batteries 102-1 through 102-N and can control charge and discharge cycles of string 110 accordingly. As illustrated, monitoring system 104-1 through 104-N captures multiple parameters regarding each of batteries 102-1 through 102-N as well as string 110 in general. For example, monitoring system 104-1 through 104-N can capture the voltage across each of batteries 102-1 through 102-N, the temperature of each of batteries 102-1 through 102-N, the pressure in each of batteries 102-1 through 102-N, the overall voltage across string 110, and the current through string 110. In some embodiments, as illustrated in FIG. 1A, a sensor 105 may be placed in string 110 and coupled directly to BMS 106 to allow BMS 106 to read the current through string 110.

Further, BMS 106 can be coupled to terminal electronics 108-1 and 108-2. Terminal electronics 108-1 and 108-2 can be configured to receive external power and provide power from battery system 100. Consequently, terminal electronics 108-1 and 108-2 are configured to control the voltage across string 110 and the current through string 110 in response to control signals from BMS 106. Monitors 104-1 through 104-N can monitor operating parameters of each of batteries 102-1 through 102-N and provide data to BMS 106 so that various operational decisions can be made.

In some embodiments, monitoring systems 104-1 through 104-N can monitor multiple parameters regarding the corresponding one of batteries 102-1 through 102-N. For example, monitoring systems 104-1 through 104-N can monitor the current, the voltage, temperature, pressure, and other parameters regarding the operation of the corresponding one of batteries 102-1 through 102-N. As shown in FIG. 1A, in some embodiments BMS 106 determines the current through string 110 using current sensor 105. Further, parameters such as the coulombic efficiency (CE), voltage efficiency (VE), and energy efficiency (EE) or other parameters that characterize the performance of each of batteries 102-1 through 102-N can be determined from the data taken by monitoring systems 104-1 through 104-N. Additionally, parameters that provide operational controls of batteries 102-1 through 102-N can be stored in BMS 106.

FIG. 1C illustrates an example of an energy rack 120 that is used to contain battery arrangement 100. Energy rack 120 contains each of batteries 102-1 through 102-N and includes all electrical connections and monitoring electronics 104-1 through 104-N to operate energy rack 120. As illustrated in the example illustrated in Figure IC, batteries 102-1 through 102-N can be packaged in pairs into individual battery packs 122. Battery packs 122-1 through 122-J are illustrated in FIG. 1C. Since each battery pack 122 includes two batteries 102, J can be N/2. Each of battery packs 122-1 through 122-J includes monitors 124-1 through 124-J, respectively. Consequently, monitors 124-1 through 124-J correspond with monitors 104-1 through 104-N as illustrated in FIG. 1A. As is further illustrated in FIG. 1C, battery management system 106 can be coupled to each of monitors 124-1 through 124-J and to terminal electronics 108-1 and 108-2.

FIG. 1D illustrates an example block diagram of a monitor 124 according to some embodiments of the present disclosure. As illustrated, monitor 124 includes a memory 126 and a processor 128. Processor 128 can be any microcomputer, microprocessor, microcontroller, ASIIC, or other device capable of executing instructions for performing the tasks described here. Memory 126 can be any combination of volatile and non-volatile memory sufficient to hold data and instructions to be executed by processor 128 for performing the tasks described here. In some embodiments, memory 126 can be used to store specific data regarding each of batteries 102 in battery pack 122, for example activation data that is compiled during the activation process or during continued operation of rack 120. In some embodiments, such data can be stored in BMS 106 instead.

As is further illustrated, processor 128 is coupled to a sensor group 130 that includes sensors that are coupled to one battery 102 of battery pack 122. Sensor group 130 includes the electronics for digitizing analog data received from individual sensors and presenting the digitized data to processor 128. In particular, sensor group 130 can include sensors for measuring various parameters regarding one of batteries 102. As discussed above, some of the parameters that may be monitored include pressure of the pressure vessel of battery 102, temperature at one or more locations on battery 102, voltage across each of batters 102, current through each of batteries 102, and other parameters. Processor 128 is further coupled to sensor group 132 that can be the same as sensor group 130 and is coupled to measure these parameters of the other one of batteries 102 in battery pack 120.

As is further illustrated, processor 128 is connected to interface 134. Interface 134 provides digital connectivity to BMS 106 as illustrated in FIG. 1C. In particular, each monitor 124 of each of battery packs 122-1 through 122-J is coupled through its interface 134 to BMS 106 of energy rack 120. In some embodiments, BMS 106 can write data to each of modules 124 and can receive data from each of monitors 124 that includes the monitor parameters for each of batteries 102 included in energy rack 120.

FIG. 1E illustrates an example of BMS 106 according to some embodiments of the present disclosure. As illustrated in FIG. 1E, BMS 106 includes a processor 140 that is coupled to a memory 142. Memory 142 can be any combination of volatile and non-volatile memory to hold data and programming instructions to perform the tasks as described here. Processor 140 can be any microcomputer, microprocessor, microcontroller, ASIIC, or other device (including combinations of individual devices) capable of executing instructions, which are stored in memory 142, for performing the tasks described here. Processor 140 can be coupled to battery interface 144, which is coupled to each of monitors 124-1 through 124-J as described above. Processor 140 can, therefore, receive data from each of monitors 124-1 through 124-J and can update data and provide instructions to monitors 124-1 through 124-J. Further, processor 140 may be coupled to current interface 154, which may be coupled to current sensor 105 as illustrated in FIG. 1A. Processor 140 can also be coupled to a rack interface 146, which can be coupled to sensors and functions, for example temperature sensors and cooling fans, within rack 120 itself. Processor 140 can also be coupled to terminal interface 148, which is coupled to battery terminal electronics 108-1 and 108-2. Consequently, processor 140 can control current and voltage across string 110 of battery 100 according to the instructions stored in memory 142. Each of battery interface 144, terminal interface 148, and rack interface 146 can include electronics for receiving signals, including analog signals, and providing digitized data to processor 140.

Processor 140 can also be coupled to an external interface 150, which allows for communications external to battery rack 120. External interface 150 can include any networking or communications protocol for communications with battery rack 120, including WiFi, cellular wireless, wired internet, or other technologies. Processor 140 can also be coupled to a local user interface 152 that can include input and display technologies for local communications with BMS 106. In some embodiments, BMS 106 can receive instructions through external interface 150 or user interface 152.

Consequently, BMS 106, interfaced with terminals 108-1 and 108-2 and monitors 124-1 through 124-J to receive data from each of batteries 102-1 through 102-N, can control charging and discharging of battery system 100, can determine the state of charge (SOC) of battery system 100 and each of batteries 102-1 through 102-N, and can monitor the top-of-charge (TOC) and bottom-of-charge (BOC) states of each of batteries 102-1 through 102-N and the TOC and BOC states of string 110. BMS 106 executes instructions for efficient charging and discharging of battery system 100 according to embodiments of the present disclosure.

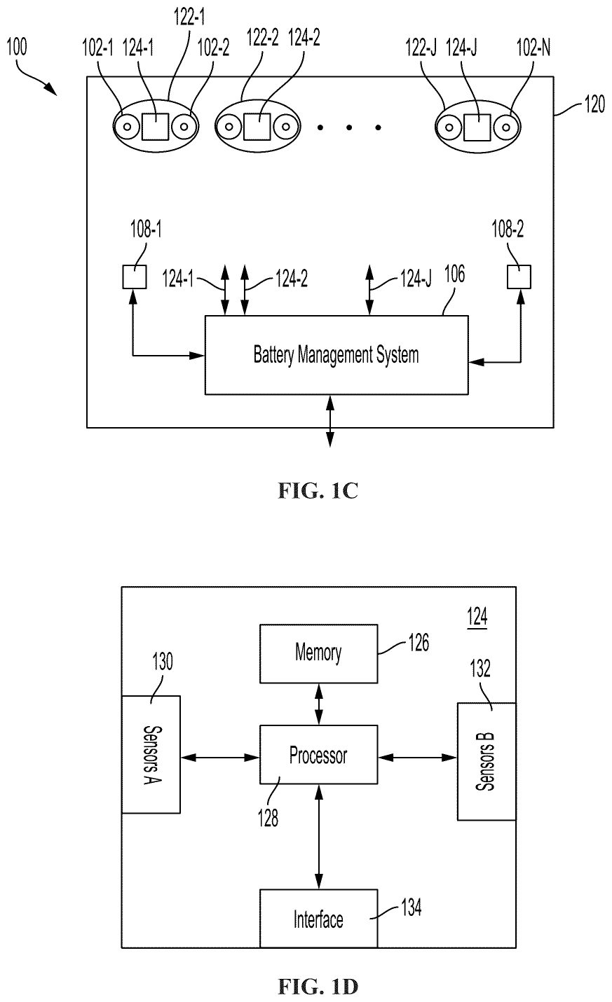

FIG. 2 illustrates a state function 200 for operation of BMS 106 according to some embodiments of the present disclosure. As is illustrated in FIG. 2, BMS 106 switches between a charge control state 202, a discharge control state 204, and an idle or inactive state 206, depending on the current operation of battery system 100. BMS 106 controls charging of battery system 100 in charge control state 202 and discharge of battery system 100 in discharge control state 204. In idle state 206, no charge or discharge is performed but BMS 106 continues to monitor battery system 100 and can transition to either charge control state 202 and discharge control state 204 as needed by the demands on battery system 100.

In some embodiments, BMS 106 can transition between charge control state 202, discharge state 204, and idle state 206 according to demands, for example from a customer. In some cases, certain transitions may be prohibited. For example, at TOC BMS 106 is prevented from moving into charge control state 202. Similarly at BOC, BMS 106 is prevented from moving into discharge control state 204. In some cases, certain faults may restrict BMS 106 to idle state 206.

In particular, battery system 100 is configured to always be coupled to a power source through a bi-directional inverter. Consequently, BMS 106 transitions between control state 202, discharge state 204, and idle state 206 in accordance with actions from a customer. BMS 106 can prevent overcharging or over-discharge, but otherwise responds to conditions that are present at any given time. In case of a fault or inactivity, BMS 106 can transition to idle state 206. In general, system 100 responds to power fluctuations like power draw, the presence of charging currents, or other factors to transition between states.

Typical charge battery control schemes operated by a battery management system either use a static maximum charge voltage, or a temperature compensated lookup table for maximum charge voltage. In particular, the common battery control system uses a constant current (CC)-constant voltage (CV) charge control scheme. In a CC-CV charge control, constant current (CC) is used as a maximum charge rate until the maximum charge voltage is reached. At this point, current tapers off as to not exceed the constant voltage (CV) limit for the remainder of the charge.

However, batteries 102 with Ni—H₂ battery chemistry allows a full speed charge from 0% to 100% without the need for tapering, as is used in the CC-CV scheme. Current compensating the maximum voltage for a CC-CV scheme is unnecessary, as a higher charge rate would simply cause entry to the CV mode sooner in a CC-CV charging scheme. Batteries 102, therefore, do not require a CC-CV scheme. Consequently, it is possible to implement a temperature and current compensated maximum charge voltage using a voltage table. In particular, in accordance with embodiments of the present disclosure, BMS 106 can execute a charging system in charging control state 202 that charges according to a lookup table, known as the “Voltage Table” or “Vtable” for short, which correlates current, maximum charge voltage, and temperature parameters. Consequently, in charge control state 202 BMS 106 charges using the current associated with the temperature and the required maximum charge voltage.

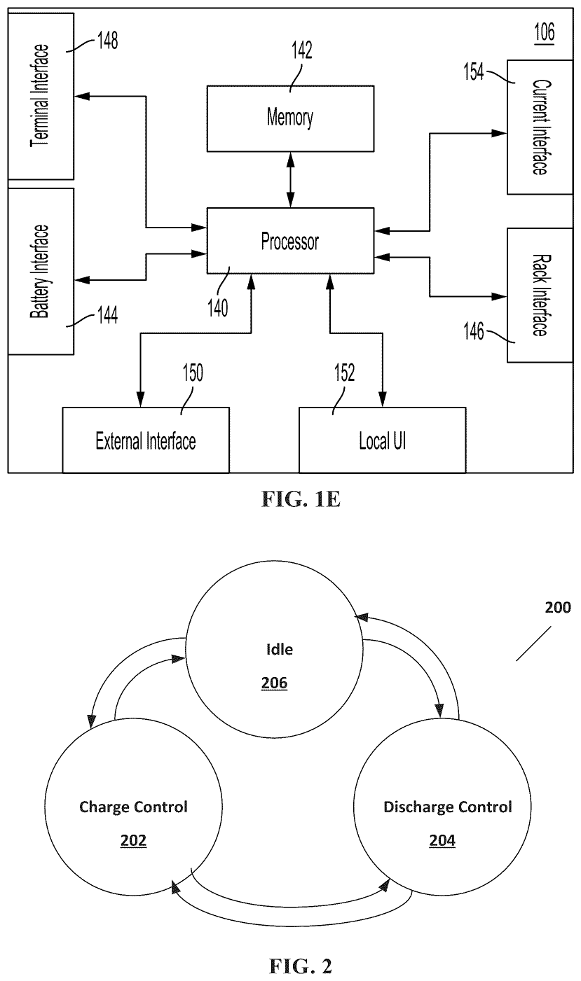

FIG. 3A illustrates an example of a charge curve that is taken on one of batteries 102. The charge curve shown in FIG. 3A illustrates the voltage of the subject battery 102 as a function of the State-of-Charge of battery 102 taken at a particular charging current and held at a particular operating temperature. A full set of such data (over various charging currents and various operating temperatures) can be used to form a 3-D Vtable as described above. In the example illustrated in FIG. 3A, the charge voltage begins dropping at approximately 125 Ah. It should be noted that the 100% nominal SOC for battery 102 used in this test can be defined as 120 Ah. This means that a point above 120 Ah, but with a safe margin below 130 Ah, can be chosen in this case for the enhanced 100% SOC to ensure reliable triggering and adequate balancing of string 110, of which battery 102 is a part. As is also illustrated in FIG. 3, the maximum voltage at around 125 Ah is just under 30.0000 V (a nominal 30V battery 102).

As discussed above, the results of a great many tests can be compiled in a 3d table, an example of which is reproduced below in Table 1. Table 1 allows for identification of a maximum charge voltage according to the current applied and the operating temperature of COPV battery 102.

TABLE 1

| Vtable | 12.5 A | 25 A | 50 A |
|---|---|---|---|
| 10 C | 27.41833 | 27.89535 | 28.42279 |
| 20 C | 27.09013 | 27.49099 | 27.95853 |
| 30 C | 26.76193 | 27.08662 | 27.49428 |
| 40 C | 26.43372 | 26.68226 | 27.03002 |
| 50 C | 26.10552 | 26.2779 | 26.56577 |

FIG. 3B illustrates a 3d Vtable that shows a maximum charge voltage surface 300 based on the data taken according to FIG. 3A and compiled in Table 1 for a battery 102. As illustrated in FIG. 3B, a maximum charge voltage surface 300 is mapped out showing the maximum charge voltage as a function of temperature and charge current. Interpolations methods can be used to determine values between data points on maximum charge voltage surface 300.

Consequently, using a 3D Vtable as described above and illustrated in FIGS. 3A and 3B allows full charge current to be used until top of charge (TOC) is reached, removing the need for a taper at TOC and simplifying multi-string integration (e.g., operation with multiple strings 110). Additionally, the Vtable trigger point (the maximum charge voltage) is precisely calibrated for the same amount of battery overcharge regardless of temperature or charge rate. This allows for an expanded window of operation, greater control over battery conditions, and precise tuning of overcharge amount for charge control balancing.

Additionally, batteries 102 degrade over time, decreasing the accuracy of their respective battery models. In some embodiments, the expected degradation of batteries 102, which may be Composite Overlay Pressure Vessel (COPV) batteries 102 as illustrated in FIG. 1B, over decades of use and tens of thousands of cycles can be characterized and a 4D Vtable created that also incorporates the degradation of batteries 102 over time. As batteries age, their voltage vs. SOC charge curves change. This can be quantified and adjusted for in the charge control scheme executed in charge control state 202. In particular, 3D data such as that illustrated in Table I and in FIG. 3B can be compiled for batteries 102 at different stages of their lifetime to create the 4D Vtable.

BMS 106, in the charge control state 202, can then interpolate between different Vtables representing the maximum charge voltages observed in batteries at different States of Health (SOH) as defined by numbers of cycles that the batteries 102 have executed. The 4D Vtable, then, correlates current, maximum charge voltage, temperature, and SOH. Most charge controllers simply decrease in modeling accuracy as the battery ages, while charge systems executed by BMS 106 in charge control state 202 according to embodiments of the present disclosure allow the user to cycle aging batteries to their maximum potential throughout their operational lifetime. Consequently, according to some embodiments of the present disclosure, charging in charge control state 202 executed by BMS 106 is accomplished according to Vtables (3D or 4D).

Adding the 4th dimension of SOH to the Vtable allows for further overcharge protection precision. Generally, charge control schemes lose precision as the batteries age. Automatically adjusting the maximum charge voltage table based on SOH allows BMS 106 to take full advantage of the long cycle life of Ni—H₂ technology used in batteries 102. Without incorporating SOH, the end of charge calculation would become increasingly inaccurate as the battery system ages, which is common in other battery systems.

In some embodiments, a consolidated Vtable that provides for the maximum charge voltage of string 110 as a function of charging current and temperature can be compiled based on the Vtable for a number of individual batteries 102. Additionally, in some embodiments, performance such as efficiency of individual batteries 102 in string 110 can be factored into the consolidated Vtable.

As discussed above with respect to FIG. 3A, determining the maximum charge voltage of a battery 102 typically involves identifying a point that will reliably terminate the charge process before damage to individual batteries 102 occurs. This is referred to as overcharge protection. NiH2 batteries, such as batteries 102, are naturally overcharge resistant to a point, and their 100% SOC point is typically a nominal value defined by the highest charge before excessive self-discharge and heat generation within each of batteries 102 begins. The electrochemical equation in an NiH2 battery is relatively stable under overcharge conditions. The eventual failure mode involves a buildup of heat leading to the pressure vessel of battery 102 venting, for example through a pressure relief burst disk.

In accordance with embodiments of the present disclosure, the charge control scheme executed by BMS 106 in charge control state 202 intentionally raises the maximum charge voltage of the lookup table (Vtable) as illustrated in Table I and FIG. 3B above the 100% nominal battery SOC point for each of batteries 102-1 through 102-N and using this raised Vtable to define battery system 100's new maximum SOC point, which is a greater than 100% nominal SOC value. This raised maximum charge voltage invokes a balancing action on the individual anode/cathode stacks within each COPV battery 102 and within the different COPV batteries 102-1 through 102-N in string 110 of system 100. The batteries 102 in string 110 with “stranded capacity,” which are those that are at a higher state of charge than the rest of the batteries 102 in string 110, are pushed into this 100%+SOC region before the maximum charge voltage indicated by the consolidated Vtable is triggered, causing those overcharged batteries 102 to bleed off a bit of their stranded capacity each time the string 110 reaches a top of charge (TOC). Whichever batteries are highest in SOC will experience the greatest self-discharge and heat generation, helping balance the string 110 formed by batteries 102-1 through 102-N as the system runs through alternating charge and discharge cycles.

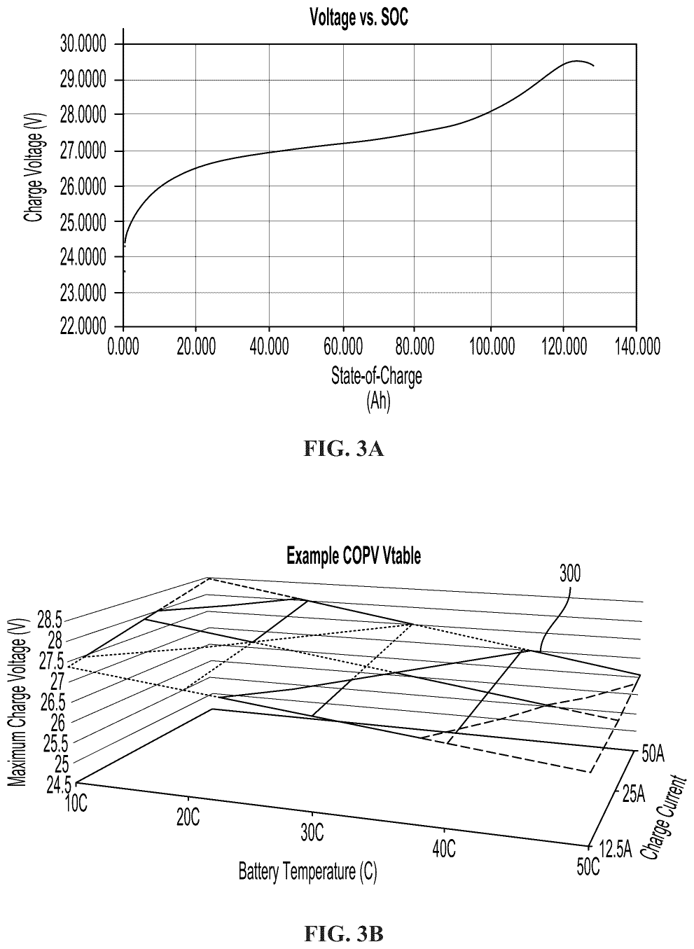

FIG. 4 illustrates operation 400 of a battery system 100 according to some embodiments of the present disclosure. FIG. 4 illustrates the efficiency ranges 404 of a battery 102 according to the nominal SOC 402. In particular, battery 102, as shown by efficiency ranges 404 and nominal SOC 402, has a high efficiency between about 10% nominal SOC and 100% nominal SOC. Battery system 100 operates at a low efficiency below 10% nominal SOC and above about 105% nominal SOC. Consequently, in a normal operational range of between 0% SOC and 100% SOC as shown by operational range 406 in FIG. 4, battery 102 does not take advantage of regions above 100% SOC and is using too much of the low efficiency region below 10% SOC. Consequently, in accordance with embodiments of the present disclosure operational range 408, which uses an SOC range that is elevated from the SOC range used in operational range 406, is utilized.

Operational range 408 works by taking advantage of the regions of high efficiency and low efficiency within the complete SOC range of a COPV battery 102. As illustrated in FIG. 4, charge control as executed in charge control state 202 intentionally sets an effective 0% SOC above that of the 0% nominal SOC of battery 102, and a system maximum SOC above the nominal 100% SOC of battery 102. By effectively raising the SOC range of a battery 102 from nominal SOCs of 0% to 100% to something closer to nominal SOCs of, for example, 5%+ to 105% +, advantage can be taken of the balancing action imparted by the low efficiency region of operation at the top of charge, while avoiding the misbalancing effect of the low efficiency region of operation at the bottom of charge.

In some embodiments, operating range 408 can be shifted from operating range 406 can be determined based on the consistency of efficiency and self discharge across different batteries 102 that can be used in string 110. The higher the variation, the more balancing will be desired and therefore the more distance from a true 0% to 100% SOC range. In some embodiments, the SOC range can be shifted by 2% to 10% from the nominal SOCs. For example, then operational range can be between 2% and 102% to between 10% and 110% of the nominal operating range 406.

Batteries 102 in string 110 that are operating in the high-SOC low efficiency region at TOC of efficiency ranges 404, but not high enough to each individual batteries 102, can shed charge and heating to balance batteries 102 in string 110. Additionally, in the low efficiency region of efficiency range 404 at BOC, batteries 102 in string 110 can be protected from undercharging damage. With normal operation 406, the lowest SOC batteries 102 in string 110 are made to operate even worse when they generate heat at BOC, exasperating the issue and possibly damaging those batteries 102. With operating range 408 according to embodiments of the present disclosure, the low performing COPV batteries 102 operate safely above 0% nominal SOC at BOC, and the overperforming COPV batteries are subject to balancing action by the low efficiency region at TOC.

The charge control system of BMS 106 in discharge control state 204 can limit the system discharge based on coulomb counting instead of a minimum battery voltage. Typically, when a maximum charge voltage defines top of charge (TOC), a minimum discharge voltage defines bottom of charge (BOC), and SOC is estimated by interpolating between these points and using a Kalman filter with an Amp-hour count. NiH₂ batteries such as batteries 102 are sensitive to over-discharge. All batteries, including COPV batteries 102, have a natural variance of coulombic efficiency (CE) and discharge capacity. COPV batteries 102 should be kept well above the theoretical minimum discharge voltage for two reasons. The first reason is that statistically certain battery stacks 114 in batteries 102 of string 110 will always reach BOC before the others, and forcing the COPV battery 102 to continue discharge after certain stacks are at 0V will permanently damage those stacks. The second reason is that even if stacks 114 in some batteries 102 of string 110 are not over-discharged, NiH₂ batteries 102 make the most heat at the end of a complete discharge. NiH₂ batteries 102 suffer worse coulombic efficiency when hot. When this happens, batteries 102 that are at the lowest SOC relative to other batteries 102 in the string 110 generate the most heat, entering the next charge cycle with worse efficiency and exaggerating string 110 and stack 114 imbalances.

Additionally, in some embodiments BMS 106 tracks discharge capacity instead of charge capacity. This allows for a more accurate reading of how much energy is left in each of batteries 102 of string 110. Reaching the maximum charge voltage that is listed in Vtable for one or more batteries 102 in string 110 is what defines 100% SOC and by extension tells the customer that 100% of the discharge capacity is available for use. To estimate SOC when charging and not yet at TOC, a recharge ratio can be used. The recharge ratio can be determined by coulomb counting using the number of Amp-hours in the battery string 110 compared with the maximum discharge capacity at TOC. The number of Amp hours going into the system can be discounted by the expected coulombic efficiency (CE) of each of batteries 102-1 through 102-N when tracking capacity. The recharge ratio can also be temperature compensated, and can be calibrated at a lower CE than the lowest performing battery 102 in the battery system 100. In some embodiments, BMS 106 can also determine and track the self discharge of each of batteries 102-1 through 102-N. As a result, batteries 102 in the string 110 will reach the maximum charge voltage according to the Vtable before the coulomb counting reaches 100% capacity at the end of every charge cycle, ensuring that slight overcharge is achieved and the balancing action described above occurs. The recharge ratio coulomb counting also serves as a backup overcharge protection. Even if BMS 106, based on reaching the maximum charging voltage listed in Vtable, has disabled overcharge, the recharge ratio coulomb counting would not allow overcharging as it would stop charge a few Amp-hours after the maximum charging voltage has been reached. If a battery string 110 is cycled without batteries 102 hitting the maximum charge voltage of the Vtable for a period of time, the recharge ratio will eventually force battery system 100 back to the parameters listed in the Vtable because the 0% SOC point will slowly rise with respect to true battery SOC due to the recharge ratio being calibrated below the efficiency of the lowest performing battery 102. Once the system reaches the maximum charging voltage listed in Vtable again, balancing action takes place and the full discharge capacity is once again available for use.

In summary, BMS 106 executes charge control that is based on the combination of a 3D or 4D maximum charge voltage lookup table, intentionally raising that lookup table to trigger above nominal battery 100% SOC, using that raised Vtable to define system 100% SOC to encourage balancing, restricting discharge capacity to encourage balancing and prolong battery life, and using a recharge ratio for SOC estimation that is calibrated just below the efficiency of the lowest performing battery 102 in the system.

Consequently, BMS 106 executing charge control according to embodiments of the present disclosure can maintain string balance and provide for reliable operation of battery string 110 with a high variance of coulombic efficiency and capacity in each of batteries 102-1 through 102-N. While balancing circuitry can mask the issue, there is no way to address the stack-to-stack balance issue within large battery modules without controlled overcharge. Additionally, limiting discharge capacity as discussed above has been shown to greatly reduce the number of COPV batteries 102 with dead battery stacks inside needing to be replaced. This increases system uptime, increases the average lifespan of the COPV batteries 102, and provides more reliable SOC estimation during discharge.

As discussed above, CC-CV charging is by far the most common charge control technique in the industry. With CC-CV, a battery is charged to a predetermined voltage point and then taper charged until current stops. This does not work well with Ni—H₂ batteries 102 because the Voltage vs. SOC graph is non-monotonic during overcharge. The use of the Vtable as discussed above allows for full speed charge at any charge rate to a SOC above 100% nominal battery SOC, which is not possible with most other battery chemistries. A 4D Vtable, which includes the SOH data, for maximum charge voltage is an additional feature. As most battery systems lose accuracy as the batteries decay instead of adapting to the changing battery parameters to maintain optimal performance, use of the 4D Vtable can provide better battery performance.

In addition to executing the charge control protocol in BMS 106 as discussed above, BMS 106 can also use a mathematical model to determine the SOC of all batteries 102-1 through 102-N in battery system 100. The mathematical model expands on concepts validated by the use of the Vtable for overcharge protection as discussed above. The Vtable charging method demonstrates that in COPV batteries 102, voltage is representative of SOC so long as the voltage is compensated by temperature and current. By characterizing many points along the Voltage/Capacity curve, as well as the effects of current and temperature at these points, interpolation operations can be performed to provide an estimate of SOC of each COPV battery 102 at any point. This estimate will be more representative of the real SOC of each individual COPV battery 102 than can be achieved with simple algorithms such as Coulomb Counting.

In some embodiments, a mathematical model of a battery 102 can use battery voltage, battery temperature, and current as its primary parameters. In some embodiments, the internal resistance for individual batteries 102 and RC time constants can also be used to characterize instantaneous changes in voltage of the battery 102 caused by changes in the applied current to provide a more accurate estimation of the SOC. The model may include current measured over the a period of time (e.g, the last 1 to 5 minutes) and may also consider the SOH of batteries 102. Similar to the function of the Vtable overcharge protections, the mathematic model may generate a number of voltage thresholds based on the measured current and temperature. The mathematical model will then output an estimated SOC for battery 102 based on the position of the measured COPV voltage relative to the threshold values. If the measured voltage falls between one of these thresholds interpolation between the available thresholds will be performed to estimate SOC more accurately.

In some embodiments, the mathematical model uses a “2RC” or “1RC” equivalent circuit model (one or two R-C circuits) to predict the performance of battery 102 resulting in the predicted SOC. In particular, the OCV (Open circuit voltage) of battery 102 at each SOC and temperature can be characterized. Once the behavior of battery 102 is characterized, an equivalent low pass RC circuit can be calculated to simulate the time delayed hysteresis behavior of the voltage.

When you stop charging the battery, the voltage settles in a decaying exponential fashion. The decay is modeled by the equivalent RC circuit, and the final voltage resting point is described by the OCV voltage. By combining these, the SOC can be accurately predicted based on Voltage, Temperature, and Current of the battery, even when the current is changing. Recent current flow through string 110 may impact measured voltages across batteries 102 for some time after current has stopped. An equivalent RC model can be used to predict the instantaneous rise and fall of the voltage due to current as well as the time-delayed voltage effects of past current through batteries 102 (i.e., the string current).

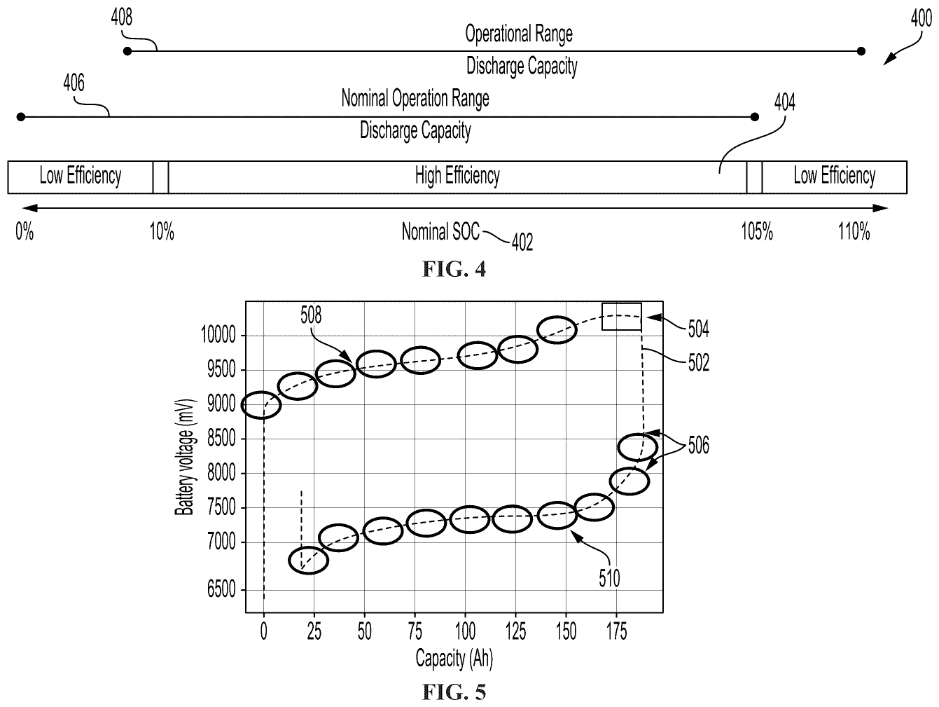

In some embodiments, the mathematical model can be simplified to only use the charge voltage, discharge voltage, and OCV. This embodiment disregards the time delayed hysteresis behavior and only considers the voltage achieved during charge, discharge, and rest, when the equivalent RC circuit is fully saturated. This can be thought of as the asymptote at the end of the decaying exponential behavior, which is illustrated in FIG. 5.

As discussed above, the hysteresis between charge and discharge voltage for a given SOC has a time delayed factor. While one embodiment of mathematical model may be a simple linear interpolation, other embodiments of the mathematical model can use an “equivalent RC model”. The RC model predicts the decaying exponential behavior of the voltage when changing from one charge rate to another. FIG. 5 illustrates a voltage vs. capacity curve with a charge-discharge curve 502. FIG. 5 illustrates a charging region 508 and a discharge region 510 in charge-discharge curve 502. The maximum charge voltage pint 504 indicated by the Vtable is also illustrated. The mathematical model builds upon principles confirmed by the Vtable approached described above. When compensated for temperature and current applied, the COPV battery voltage can consistently represent SOC. With enough points strongly characterized this will provide a complete model for cell SOC at any point during operation of battery 102. Additional testing and analysis will be performed to allow the model to compensate for hysteresis in the cell's voltage with changing current. Consequently, the mathematical model includes data at points 506 along charge-discharge curve 502 which will allow the mathematical model to characterize the SOC of each battery 102 in string 110 based on voltage across battery 102.

The mathematical modeling method allows for a balancing technique to be utilized in battery system 100. In most battery pack applications, there are limited opportunities for balancing cells. Depending on cell chemistry, balancing will typically be applied at TOC or BOC, leading to downtime when these processes become necessary. By applying the mathematical model in BMS 106, battery system 100 has the ability to perform balancing at any time during the operation of battery system 100. Using the mathematical model, BMS 106 can provide instantaneous estimates of SOC for all of COPV batteries 102 in string 110. This will allow BMS 106 to make comparisons of the SOC for all COPV batteries 102 and compare them against each other, driving decisions for passive balancing at any time during charge state 202, discharge state 204, or rest 206. Further, BMS 106 can also determine when to apply trickle charging to rebalance cells at TOC in idle mode 206. Handling imbalances proactively during operation will decrease system imbalance, deter degradation of COPV batteries 102 caused by imbalance, and increase system uptime.

The utility provided by a measurement based mathematical model of the SOC of each of batteries 102-1 through 102-N is three-fold. The first aspect to consider is the traceability and predictability provided by a model that is not mathematically complex. The mathematical model described above relies on input data that is collected as standard for most battery packs: cell voltage, temperature, and current. These parameters are characterized extensively such that the only computations performed are linear interpolations between known points on a 3D plane. Because of this, logical decisions made by the model will be predictable and in field applications will be easily traceable based on regularly collected data.

A second benefit provided by the mathematical modeling is the enhancement to system efficiency. A primary driver of efficiency losses in an energy storage system is imbalance between the cells limiting available discharge capacity. These losses occur in both a short and long term sense. On a single cycle basis, operating limits are enforced based on the worst performing COPV battery 102, meaning that others are likely to be leaving energy unutilized. Considering the lifetime of the system, lower performing vessels will be pushed closer to their operational limits, leading to a faster rate of degradation compared to other higher performing batteries 102. By maintaining an improved system balanced through controlled passive and active balancing, the spread of vessel performance should become more narrow. This leads to higher system efficiency, as well as a reduced loss in performance as the system gets closer to its end-of-life.

Additionally, observing SOC at a single battery level compared to at the system level only, increased visibility to the performance of individual components of battery system 100 is achieved. This will provide for more informed decisions regarding service. Further, underperforming batteries 102 can be detected and replaced before faults are present, increasing system up-time.

Performing balancing operations in the early stages of charge or discharge in battery system 100 is atypical for a battery storage system. Most systems leverage balancing techniques like parallel modules or trickle charge at TOC. The challenges of implementing a terrestrial NiH2 battery system 100 cause these known techniques to be insufficient for maintaining a healthy system condition. NiH2 batteries 102 have a lower energy density compared to lithium, meaning that all batteries 102 are generally connected in series to provide a competitive voltage output for the physical footprint of battery system 100. This rules out passive balancing through parallel connections. Additionally, the high level of self-discharge present in NiH2 batteries 102 calls for alternative methods to TOC trickle charge, as this would be extremely time consuming on its own. However, embodiments of the present disclosure can use TOC trickle charge to rebalance batteries 102. These challenges demonstrate the need for an atypical process to perform system balancing, which could provide a larger amount of balancing capacity without effecting system uptime. The mathematical model tackles this by recognizing and correcting imbalance in the system early on in cycles, allowing for more substantial corrections with less interruption to normal operation.

Consequently, embodiments of the present disclosure implements a charging state 202 with a Vtable that correlates a maximum charge voltage with charging current and temperature of each battery 102 in a string 110. In particular, the Vtable has been shifted to reflect a shifted SOC range. Additionally, the Vtable can include the state-of-health (SOH) such that the Vtable approach can be utilized throughout the lifetime of battery system 100. Long-term data from battery systems 100 allow for creation of Vtables with the SOH data.

Using an elevated Vtable (shifted SOC range) for controlling TOC overcharge can also provide for balancing. Discharge capacity can also be limited for battery life and balancing. Accurate SOC predictions can be made based on recharge ratios using the measured voltages across batteries 102 in string 110.

Mathematically modeling the SOC of each of batteries 102 in string 110 can allow for accurate predictions of the SOC of each of batteries 102 in string 110 based on the voltage measured at batteries 102. Accurate predictions of each of batteries 102 provide data for decisions of discharge or charge rates and balancing of batteries 102 in string 110.

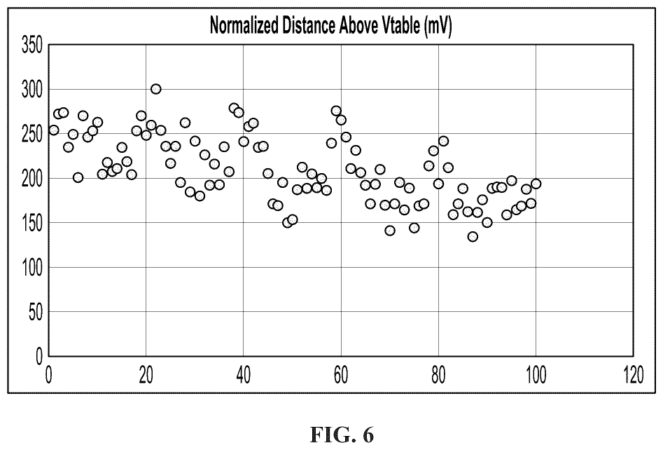

FIG. 6 illustrates an example of charge control on several batteries 102 according to some embodiments of the present application. In this example, several batteries 102 were intentionally overcharged until all batteries 102 in the test experienced their maximum overcharge voltage. These maximum voltages were normalized against their respective Vtable values and the known voltage measurement offsets that may be present in BMS 106. The results shown in FIG. 6 illustrate that the Vtable control system as described above is a reliable method of overcharge protection, as in this example 100 out of 100 batteries 102 crossed the fault threshold. The results also show that there is room to raise the Vtable charge voltage limits in order to invoke battery balancing at TOC without jeopardizing its effectiveness as an overcharge protection.

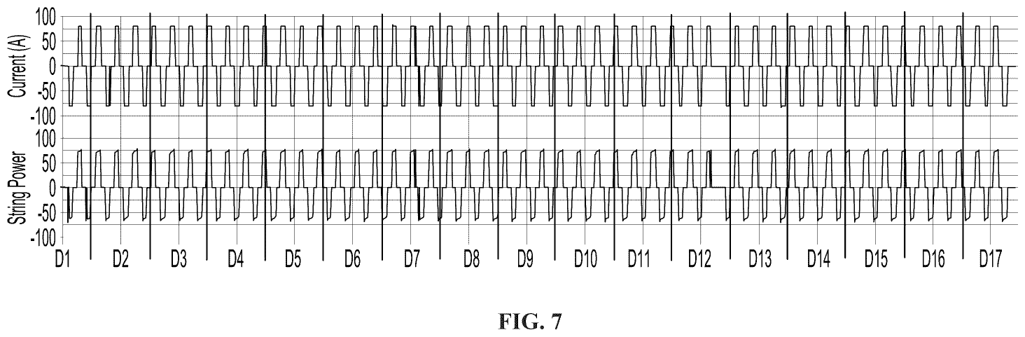

FIG. 7 illustrates an example system undergoing alternating charge and discharge cycles over several days. The system illustrated in FIG. 7 is executing a battery management system as described above. Consequently, the charge control for the system illustrated in FIG. 7 cycles 50 times at the maximum charge and discharge rate back-to-back with no intervention and no auxiliary balancing procedures or mechanisms, illustrating the vitality of battery management according to some embodiments of the present disclosure.

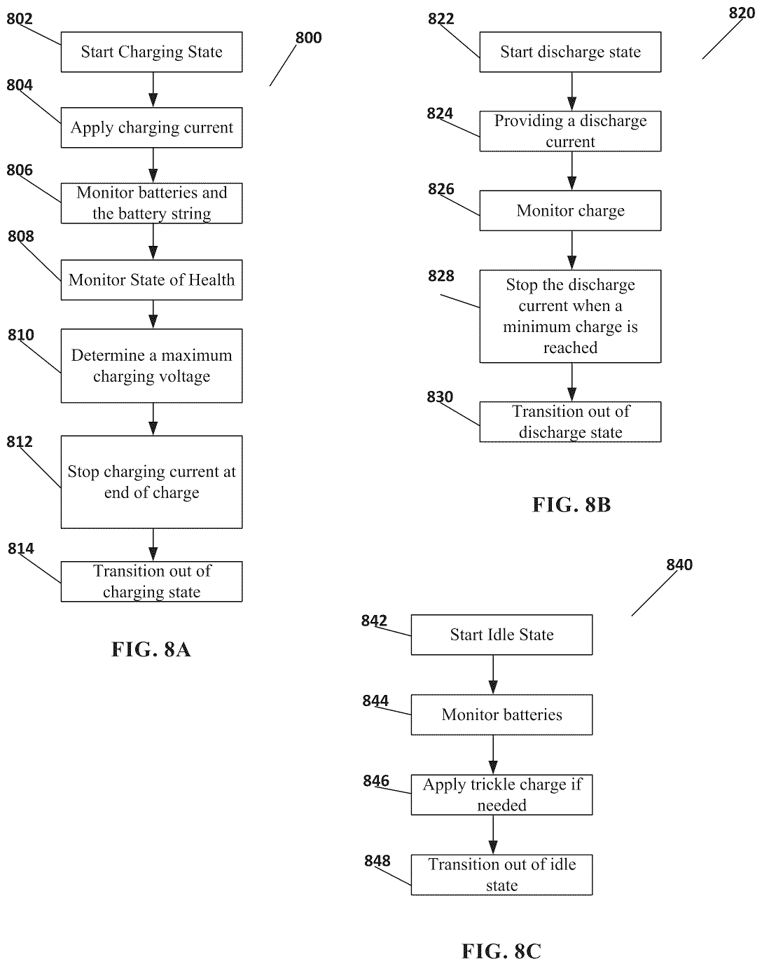

FIGS. 8A, 8B, and 8C illustrate methods of operation of BMS 106 according to some embodiments according to this disclosure. In particular, FIG. 8A illustrates a charging method 800 that can be executed by BMS 106 in charge control state 202. FIG. 8B illustrates a discharging method 820 that can be executed by BMS 106 in discharge control state 204. FIG. 8C illustrates an idle method 840 that can be executed in idle state 206.

As illustrated in FIG. 8A, charging method 800 begins at step 802 when charging control state 202 is entered. In step 804, BMS 106 applies a charging current through battery string 110. As discussed above, battery string 110 includes a plurality of individual batteries 802 that are coupled, for example in series. The charging current can be set at a high level so that maximum charging can be applied. In some embodiments, the charging current can be adjusted during the charge in response to conditions of individual batteries 102 of battery string 110.

In step 806, batteries 102 and battery string 110 are monitored. In particular, a temperature of battery string 110 can be determined. The temperature can, for example, be an average of the temperatures determined for individual batteries 102 in battery string 110 or the temperature of battery string 110 may be determined in other ways (e.g., with separate temperature sensors).

Further, in step 806, the voltage, current, temperature, and pressure of each of batteries 102 in battery string 110 can be monitored. Additionally, the state-of-charge of battery string 110 and each individual battery 102 in battery string 110 can be determined based on the monitored parameters. Consequently, in some embodiments the conditions of each of the plurality of batteries 102 in battery string 110 can be determined. In some embodiments, the condition of each of batteries 102 in battery string 110 is determined based on a mathematical model that is a function of the parameters measured at each battery. In some embodiments, the mathematical model can estimate the state-of-charge. In some embodiments, the charging current can be adjusted based on the estimated condition of each of batteries 102 in string 110.

Additionally, monitoring step 806 can track charge can be determined by monitoring charge by coulomb counting and using a Kalman filter. This allows for tracking discharge capacity of the battery string. A state-of-charge during charging can be determined using a recharging ratio, which is determined by coulomb counting the number of amp-hours in the battery string. In some embodiments, the number of amp-hours is discounted according to coulombic efficiency of each of batteries 102-1 through 102-N. In some embodiments, the number of amp-hours can be temperature compensated. In some embodiments, the recharging ratio is calibrated with a lower coulombic efficiency than a lowest performing battery of the plurality of batteries. In some embodiments, charging method 800 can determining the state-of-health (SOH) of batteries 102 in battery string 110 in step 808. In some embodiments, the number of charge/discharge cycles can be used to adjust a Vtable according to the age of battery string 110 in order to provide more efficient operation as battery string 110 ages. In step 810, charging method 800 determines a maximum charging voltage for each of batteries 102-1 through 102-N based on a Vtable, which as discussed above may be adjusted for state of health. The Vtable relates the charging current and temperature of the battery string to a maximum charging voltage. The maximum charging voltage can be used to determine when one or more batteries 102 have reached its maximum voltage and that battery string 110 has reached its top-of-charge, and therefore the charging cycle is complete. In some embodiments, the Vtable can also include the state-of-health so that the Vtable relates the charging current, temperature, and SOH of the battery string to the maximum charging voltage. As discussed above, the Vtable is set so that the maximum charging voltage indicates a SOC for batteries 102 in battery string 110 that is above 100% nominal SOC. In some embodiments, the maximum charging voltage is set high enough so that the SOC of battery string 110 is high enough to promote balancing of individual batteries 102 in battery string 110.

In step 812, charging method 800 stops the charging current at the end of the charging cycle. As suggested above, the charging current is stopped when the battery voltage reaches or exceeds the maximum charging voltage indicating that battery string 110 is at the TOC. In some embodiments, the recharging ratio can also be used to determine the TOC and charging method 800 stopped on that basis. In step 814, once charging control state 204 is finished, BMS 106 transitions to either discharge control state 804 or idle state 806, as is described above.

FIG. 8B illustrates a discharge method 820 that is executed during discharge control state 204. Discharge method 820 starts in step 822 when BMS 106 transitions to discharge control state 204. In step 824, discharge method 820 provides control signals to provide a discharge current as is required.

While the discharge current is being supplied, in step 826 battery string 110 and individual batteries 102 are being monitored as described above. In some embodiments, the discharge state is determined, and controlled, based on coulomb counting. In some embodiments, the SOC of the battery can be determined by interpolation between the maximum charge voltage defining a top-of-charge and a minimum discharge voltage defining a bottom-of-charge state and using a Kalman filter with an amp-hour count. The minimum discharge voltage, which can be defined for each of batteries 102, can be set high enough such that none of the plurality of batteries in the battery string are over discharged at the SOC defined by the minimum discharge voltage. In some embodiments, the minimum discharge voltage is based on a battery of the plurality of batteries that will reach the bottom-of-charge state during discharge before other batteries of the plurality of batteries.

In step 828, the discharge current is stopped when a minimum charge on one of batteries 102 in battery string 110 is reached. In step 830, discharge control method 820 transitions out of the discharge state 204. Consequently, BMS 106 transitions to either a charge control state 202 or idle state 206, as is described above.

FIG. 8C illustrates an idle method 840 for execution during idle state 206, which starts in start idle state step 842. As illustrated, idle method 840, in step 844 batteries 102 of battery string 110 are monitored. In step 846, BMS 106 may arrange for a trickle charge of battery string 110. A trickle charge is a small current that will allow battery string 110 to maintain a full charge and promotes balancing of batteries 102 in battery string 110. In step 848, BMS 106 transitions out of an idle state into either the charge control state 202 or the discharge control state 204, as described above.

As such, aspects of the current disclosure are described below.

Aspect 1: A method of managing a battery system, comprising: applying a charging current through a battery string of the battery system, the battery string including a plurality of coupled batteries; monitoring temperature of the plurality of batteries; determining a maximum charging voltage from a Vtable that relate the charging current, the temperature, and the maximum charging voltage for each battery in the battery string; and stopping the charging current when a voltage across one or more of the batteries of the battery string reaches the maximum charging voltage.

Aspect 2: The method of Aspect 1, further including: monitoring a state of health (SOH) of the plurality of coupled batteries, wherein the Vtables relate the charging current, the temperature, the maximum charging voltage, and the SOH.

Aspect 3: The method of Aspects 1 or 2, wherein the maximum charging voltage is set in the Vtable such that, when the voltage across one of the batteries in the battery string is at the maximum charging voltage, that battery is at a state-of-charge (SOC) greater than a nominal SOC of 100%.

Aspect 4: The method of any of Aspects 1-3, wherein the maximum charging voltage is set high enough to promote balancing of the plurality of batteries in the battery string at the top of charge.

Aspect 5: The method of any of Aspects 1-4, further including monitoring parameters regarding each of the plurality of batteries in the battery string; and determining conditions of each of the plurality of batteries based on a mathematical model.

Aspect 6: The method of Aspect 5, wherein monitoring parameters includes determining a voltage across each battery in the plurality of batteries.

Aspect 7: The method of any of Aspects 4-6, wherein determining conditions includes determining a state-of-charge.

Aspect 8: The method of any of Aspects 4-6, further including adjusting the charging current in response to the determined conditions of each of the plurality of batteries.

Aspect 9: The method of any of Aspects 1-8, including transitioning to an idle state.

Aspect 10: The method of Aspect 9, wherein transition to the idle state occurs after stopping the charging current or in response to conditions of one or more of the plurality of batteries in the battery string.

Aspect 11: The method of any of Aspects 1-10, further including applying a trickle charge current during the idle state.

Aspect 12: The method of any of Aspects 10-11, wherein applying the trickle charge current enhances balancing of the battery string.

Aspect 13: The method of any of Aspects 1-12, further including transitioning to a discharge state.

Aspect 14: The method of any of Aspects 10-13, further including in the discharge state, providing discharge current from the battery string and stopping the discharge current when a minimum discharge voltage is reached.

Aspect 15: The method of any of Aspects 1-14, further including controlling the discharge capacity based on coulomb counting.

Aspect 16: The method of any of Aspects 1-15, further including determining the SOC of the battery by interpolation between the maximum charge voltage defining a top-of-charge and a minimum discharge voltage defining a bottom-of-charge state and using a Kalman filter with an amp-hour count.

Aspect 17: The method of Aspect 16, wherein the minimum discharge voltage is set high enough such that none of the plurality of batteries in the battery string are over discharged at the SOC defined by the minimum discharge voltage.

Aspect 18: The method of any of Aspects 16-17, wherein the minimum discharge voltage is based on a battery of the plurality of batteries that will reach the bottom-of-charge state during discharge before other batteries of the plurality of batteries.

Aspect 19: The method of any of Aspects 1-18, further including tracking discharge capacity of the battery string.

Aspect 20: The method of any of Aspects 1-19, further including estimating a state-of-charge during charging using a recharging ratio, which is determined by coulomb counting the number of amp-hours in the battery string.

Aspect 21: The method of Aspect 20, wherein the number of amp-hours is discounted according to coulombic efficiency of each of the plurality of batteries.

Aspect 22: The method of Aspects 19-21, wherein the number of amp-hours can be temperature compensated.

Aspect 23: The method of Aspects 20-22, wherein the recharging ratio is calibrated with a lower coulombic efficiency than a lowest performing battery of the plurality of batteries.

Aspect 24: A battery management system (BMS), the BMS comprising: a battery interface configured to communicate with battery monitors, the battery monitors configured to monitor parameters of a plurality of batteries, the plurality of batteries being coupled to form a battery string; a terminal interface, the configured to communicate with terminal electronics, the terminal electronics configured to control current and voltage of the battery string in accordance with control signals received from the terminal interface; a memory, the memory configured to hold instructions and data; and a processor coupled to the memory, the terminal interface, and the battery interface, wherein the processor executes instructions stored in the memory to provide control signals to the terminal interface to direct the terminal electronics to apply a charging current through the battery string, the battery string including a plurality of coupled batteries; monitor temperature of the plurality of batteries through the battery interface; determine a maximum charging voltage from a Vtable that relate the charging current, the temperature, and the maximum charging voltage for each of the plurality of batteries; provide control signals to the terminal interface to stop the charging current when a voltage across one or more of the plurality of batteries in the battery string reaches the maximum charging voltage.

Aspect 25: The BMS of Aspect 24, further including instructions to: monitor a state of health (SOH) of the plurality of coupled batteries, wherein the Vtables relate the charging current, the temperature, the maximum charging voltage, and the SOH.

Aspect 26: The BMS of any of Aspects 24-25, wherein the maximum charging voltage is set in the Vtable such that, when the voltage across one of the batteries in the battery string is at the maximum charging voltage corresponding to a top of charge (TOC), that battery is at a state-of-charge (SOC) greater than a nominal SOC of 100%.

Aspect 27: The BMS of Aspect 26, wherein the maximum charging voltage is set high enough to promote balancing of the plurality of batteries in the battery string at the TOC.

Aspect 28: The BMS of any of Aspects 24-27, further including instructions to monitor parameters through the battery interface regarding each of the plurality of batteries in the battery string; and determine conditions of each of the plurality of batteries based on a mathematical model.

Aspect 29: The BMS of Aspect 28, wherein monitoring parameters includes determining a voltage across each battery in the plurality of batteries.

Aspect 30: The BMS of Aspect 29, wherein determining conditions includes determining a state-of-charge of each of the plurality of batteries.

Aspect 31: The BMS of any of Aspects 24-30, further including instructions to adjust the charging current in response to the determined conditions of each of the plurality of batteries.

Aspect 32: The BMS of Aspects 24-31, including instructions to transition to an idle state.

Aspect 33: The BMS of Aspect 32, wherein transition to the idle state occurs after stopping the charging current or in response to conditions of one or more of the plurality of batteries in the battery string.

Aspect 34: The BMS of Aspects 32-33, further including instructions to provide control signals through the terminal interface to apply a trickle charge current during the idle state.

Aspect 35: The BMS of Aspect 34, wherein applying the trickle charge current enhances balancing of the battery string.

Aspect 36: The BMS of Aspects 24-35, further including instructions to transition to a discharge state.

Aspect 37: The BMS of Aspect 36, further including instructions for, in the discharge state, to provide control signals to the terminal interface for providing discharge current from the battery string.

Aspect 38: The BMS of Aspect 37, further including instructions to control a discharge capacity based on coulomb counting.

Aspect 39: The BMS of Aspect 24-38, further including instructions to determine the SOC of the battery by interpolation between the maximum charge voltage defining a top-of-charge and a minimum discharge voltage defining a bottom-of-charge state and using a Kalman filter with an amp-hour count.

Aspect 40: The BMS of Aspect 39, wherein the minimum discharge voltage is set high enough such that none of the plurality of batteries in the battery string are over discharged at the SOC defined by the minimum discharge voltage.

Aspect 41: The BMS of any of Aspects 39-40, wherein the minimum discharge voltage is based on a battery of the plurality of batteries that will reach the bottom-of-charge state during discharge before other batteries of the plurality of batteries.

Aspect 42: The BMS of any of Aspects 24-41, further including instructions to track discharge capacity of the battery string.

Aspect 43: The BMS of Aspects 24-42, further including instructions to estimate a state-of-charge during charging using a recharging ratio, which is determined by coulomb counting the number of amp-hours in the battery string.

Aspect 44: The BMS of Aspect 43, wherein the number of amp-hours is discounted according to coulombic efficiency of each of the plurality of batteries.

Aspect 45: The BMS of Aspect 44, wherein the number of amp-hours can be temperature compensated.

Aspect 46: The BMS of Aspect 45, wherein the recharging ratio is calibrated with a lower coulombic efficiency than a lowest performing battery of the plurality of batteries.

The above detailed description is provided to illustrate specific embodiments of the present invention and is not intended to be limiting. Numerous variations and modifications within the scope of the present invention are possible. The present invention is set forth in the following claims.

What is claimed is:

1. A method of managing a battery system, comprising:
applying a charging current through a battery string of the battery system, the battery string including a plurality of coupled batteries;
monitoring temperature of the plurality of batteries;
determining a maximum charging voltage from a Vtable that relate the charging current, the temperature, and the maximum charging voltage for each battery in the battery string; and
stopping the charging current when a voltage across one or more of the batteries of the battery string reaches the maximum charging voltage.

2. The method of claim 1, further including:
monitoring a state of health (SOH) of the plurality of coupled batteries, wherein the Vtables relate the charging current, the temperature, the maximum charging voltage, and the SOH.

3. The method of claim 1, wherein the maximum charging voltage is set in the Vtable such that, when the voltage across one of the batteries in the battery string is at the maximum charging voltage, that battery is at a state-of-charge (SOC) greater than a nominal SOC of 100%.

4. The method of claim 3, wherein the maximum charging voltage is set high enough to promote balancing of the plurality of batteries in the battery string at the top of charge.

5. The method of claim 1, further including
monitoring parameters regarding each of the plurality of batteries in the battery string; and
determining conditions of each of the plurality of batteries based on a mathematical model.

6. The method of claim 5, wherein monitoring parameters includes determining a voltage across each battery in the plurality of batteries.

7. The method of claim 6, wherein determining conditions includes determining a state-of-charge.

8. The method of claim 6, further including adjusting the charging current in response to the determined conditions of each of the plurality of batteries.

9. The method of claim 7, including transitioning to an idle state.

10. The method of claim 9, wherein transition to the idle state occurs after stopping the charging current or in response to conditions of one or more of the plurality of batteries in the battery string.

11. The method of claim 9, further including applying a trickle charge current during the idle state.

12. The method of claim 10, wherein applying the trickle charge current enhances balancing of the battery string.

13. The method of claim 7, further including transitioning to a discharge state.

14. The method of claim 12, further including in the discharge state, providing discharge current from the battery string and stopping the discharge current when a minimum discharge voltage is reached.

15. The method of claim 14, further including controlling the discharge capacity based on coulomb counting.

16. The method of claim 15, further including determining the SOC of the battery by interpolation between the maximum charge voltage defining a top-of-charge and a minimum discharge voltage defining a bottom-of-charge state and using a Kalman filter with an amp-hour count.

17. The method of claim 16, wherein the minimum discharge voltage is set high enough such that none of the plurality of batteries in the battery string are over discharged at the SOC defined by the minimum discharge voltage.

18. The method of claim 17, wherein the minimum discharge voltage is based on a battery of the plurality of batteries that will reach the bottom-of-charge state during discharge before other batteries of the plurality of batteries.

19. The method of claim 1, further including tracking discharge capacity of the battery string.

20. The method of claim 19, estimating a state-of-charge during charging using a recharging ratio, which is determined by coulomb counting the number of amp-hours in the battery string.

21. The method of claim 20, wherein the number of amp-hours is discounted according to coulombic efficiency of each of the plurality of batteries.

22. The method of claim 21, wherein the number of amp-hours can be temperature compensated.

23. The method of claim 20, wherein the recharging ratio is calibrated with a lower coulombic efficiency than a lowest performing battery of the plurality of batteries.

24. A battery management system (BMS), the BMS comprising:
a battery interface configured to communicate with battery monitors, the battery monitors configured to monitor parameters of a plurality of batteries, the plurality of batteries being coupled to form a battery string;
a terminal interface, the configured to communicate with terminal electronics, the terminal electronics configured to control current and voltage of the battery string in accordance with control signals received from the terminal interface;
a memory, the memory configured to hold instructions and data; and
a processor coupled to the memory, the terminal interface, and the battery interface, wherein the processor executes instructions stored in the memory to
provide control signals to the terminal interface to direct the terminal electronics to apply a charging current through the battery string, the battery string including a plurality of coupled batteries;
monitor temperature of the plurality of batteries through the battery interface;
determine a maximum charging voltage from a Vtable that relate the charging current, the temperature, and the maximum charging voltage for each of the plurality of batteries;
provide control signals to the terminal interface to stop the charging current when a voltage across one or more of the plurality of batteries in the battery string reaches the maximum charging voltage.

25. The BMS of claim 24, further including instructions to:
monitor a state of health (SOH) of the plurality of coupled batteries, wherein the Vtables relate the charging current, the temperature, the maximum charging voltage, and the SOH.

26. The BMS of claim 24, wherein the maximum charging voltage is set in the Vtable such that, when the voltage across one of the batteries in the battery string is at the maximum charging voltage corresponding to a top of charge (TOC), that battery is at a state-of-charge (SOC) greater than a nominal SOC of 100%.

27. The BMS of claim 26, wherein the maximum charging voltage is set high enough to promote balancing of the plurality of batteries in the battery string at the TOC.

28. The BMS of claim 24, further including instructions to
monitor parameters through the battery interface regarding each of the plurality of batteries in the battery string; and
determine conditions of each of the plurality of batteries based on a mathematical model.

29. The BMS of claim 28, wherein monitoring parameters includes determining a voltage across each battery in the plurality of batteries.

30. The BMS of claim 29, wherein determining conditions includes determining a state-of-charge of each of the plurality of batteries.

31. The BMS of claim 30, further including instructions to adjust the charging current in response to the determined conditions of each of the plurality of batteries.

32. The BMS of claim 31, including instructions to transition to an idle state.

33. The BMS of claim 32, wherein transition to the idle state occurs after stopping the charging current or in response to conditions of one or more of the plurality of batteries in the battery string.

34. The BMS of claim 33, further including instructions to provide control signals through the terminal interface to apply a trickle charge current during the idle state.

35. The BMS of claim 34, wherein applying the trickle charge current enhances balancing of the battery string.

36. The BMS of claim 35, further including instructions to transition to a discharge state.

37. The BMS of claim 36, further including instructions for, in the discharge state, to provide control signals to the terminal interface for providing discharge current from the battery string.

38. The BMS of claim 37, further including instructions to control a discharge capacity based on coulomb counting.

39. The BMS of claim 38, further including instructions to determine the SOC of the battery by interpolation between the maximum charge voltage defining a top-of-charge and a minimum discharge voltage defining a bottom-of-charge state and using a Kalman filter with an amp-hour count.

40. The BMS of claim 39, wherein the minimum discharge voltage is set high enough such that none of the plurality of batteries in the battery string are over discharged at the SOC defined by the minimum discharge voltage.

41. The BMS of claim 40, wherein the minimum discharge voltage is based on a battery of the plurality of batteries that will reach the bottom-of-charge state during discharge before other batteries of the plurality of batteries.

42. The BMS of claim 24, further including instructions to track discharge capacity of the battery string.

43. The BMS of claim 42, further including instructions to estimate a state-of-charge during charging using a recharging ratio, which is determined by coulomb counting the number of amp-hours in the battery string.

44. The BMS of claim 43, wherein the number of amp-hours is discounted according to coulombic efficiency of each of the plurality of batteries.

45. The BMS of claim 44, wherein the number of amp-hours can be temperature compensated.

46. The BMS of claim 45, wherein the recharging ratio is calibrated with a lower coulombic efficiency than a lowest performing battery of the plurality of batteries.
